(19) United States
(12) Patent Application Publication
(10) Pub. No.: US 2025/0110862 A1
(43) Pub. Date: Apr. 3, 2025

(54) FRAGMENT TIERING

(71) Applicant: Dropbox, Inc., San Francisco, CA (US)

(72) Inventors: Sandeep Kumar R. Ummadi, Issaquah, WA (US); Facundo Agriel, Seattle, WA (US); Ankur Kulshrestha, Issaquah, WA (US)

(21) Appl. No.: 18/375,135

(22) Filed: Sep. 29, 2023

(51) Int. Cl. G06F 12/02

(52) U.S. Cl. CPC G06F 12/023

(57) ABSTRACT

A system receives a request for a data block, in which the data block corresponds to a set of fragments, and the data block can be fully reconstructed using a threshold number of the set of fragments. A first subset of the set of fragments are stored in a first storage system, and a second subset of the set of fragments are stored in a second storage system characterized by a higher average latency than the first storage system. A system, responsive to receiving the request for the data block, requests the first subset of the set of fragments. A system receives at least the threshold number of the first subset of the fragments. A system reconstructs the data block using the received fragments of the first subset of the fragments. A system provides the reconstructed data block.

### TECHNICAL FIELD

The disclosed embodiments generally relate to the optimization and efficiency of data storage by fragmenting data and designating the storage of those fragments.

### BACKGROUND

In scenarios where data integrity and availability guarantees are required, storage of redundant copies of data may be required. The storage of multiple copies of data for the sake of redundancy often comes at the expense of storage capacity. The more copies of data that are stored, and the larger those copies are, the more storage is needed. Fragmenting data and saving only portions of the data across multiple storage options helps mitigate the storage needs but still runs into the same issues once a storage limit has been reached. Further inefficiencies also arise when the data needs to be used, as the fragments then need to be retrieved and the data reconstructed. This is especially problematic in that once a system is set up and a set of tradeoffs chosen, logistical challenges exist that may prevent dynamically changing the system to meet the needs of the data and system as it changes.

### SUMMARY

By fragmenting data blocks and storing the fragments across multiple storage systems each with different characteristics, a system is able to be flexible in balancing the needs for redundancy, efficiency, cost and storage capacity limits based on the changing demands on the system in real time. A system that stores fragments across different storage systems with different characteristics, such as different average read and/or write latency, can optimize the tradeoffs of efficiency and redundancy. A system which can migrate data blocks and fragments among storage systems can respond to changing needs for different storage capacities. By fragmenting the data block across these storage systems with different average latency and requesting the fragments from systems with a lower average latency, the system can optimize for the efficiency of retrieval of data blocks while still maintaining an optimal redundancy for the data blocks across the system.

In some embodiments, in response to a request for some specific data which has been fragmented across two storage systems with different average latency, the system fragment requests the fragments stored in the system with a lower average latency and upon receiving at least fragment the required number of fragments for reconstructing the data, reconstructs the data using the received fragments. In some embodiments, upon failing to receive the required number of fragments, the system requests more fragments from a second system with higher average latency to enable reconstruction of the data.

### BRIEF DESCRIPTION OF THE DRAWINGS

FIG. 1 shows a diagram of a system environment of a content management system and a collaborative content management system, according to example embodiments.

FIG. 2 shows a block diagram of components of a client device, according to example embodiments.

FIG. 3 shows a block diagram of a content management system, according to example embodiments.

FIG. 4 shows a block diagram of a collaborative content management system, according to example embodiments.

FIG. 5 shows a block diagram of a fragment tiering system, according to example embodiments.

FIG. 6A shows data blocks divided into fragments, according to some example embodiments.

FIG. 6B shows a block diagram of a data blocks fragmented across a storage system, according to example embodiments.

FIG. 7 shows the block diagram of the fragment tiering system across two storage systems, in accordance with some embodiments.

FIG. 8 shows a flowchart of an example method of a fragment tiering system, according to example embodiments.

The figures depict various example embodiments of the present technology for purposes of illustration only. One skilled in the art will readily recognize from the following description that other alternative example embodiments of the structures and methods illustrated herein may be employed without departing from the principles of the technology described herein.

### DETAILED DESCRIPTION

### System Overview

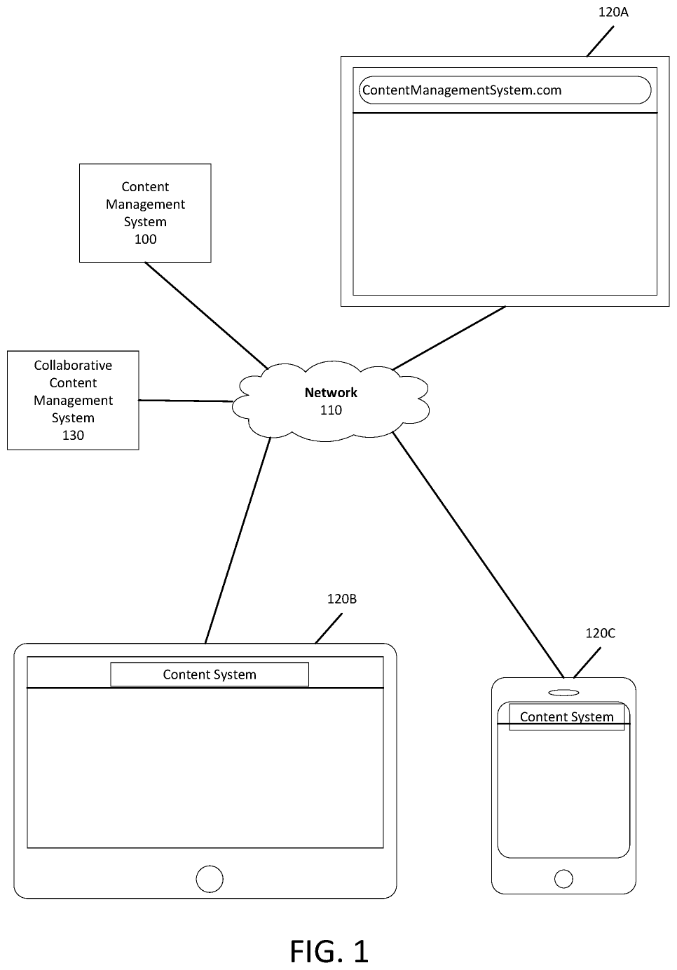

FIG. 1 shows a system environment including content management system 100, collaborative content management system 130, and client devices 120a, 120b, and 120c (collectively or individually “120”). Content management system 100 provides functionality for sharing content items with one or more client devices 120 and synchronizing content items between content management system 100 and one or more client devices 120.

The content stored by content management system 100 can include any type of content items, such as documents, spreadsheets, collaborative content items, text files, audio files, image files, video files, webpages, executable files, binary files, placeholder files that reference other content items, etc. In some implementations, a content item can be a portion of another content item, such as an image that is included in a document. Content items can also include collections, such as folders, namespaces, playlists, albums, etc., that group other content items together. The content stored by content management system 100 may be organized in one configuration in folders, tables, or in other database structures (e.g., object oriented, key/value etc.).

In some example embodiments, the content stored by content management system 100 includes content items created by using third party applications, e.g., word processors, video and image editors, database management systems, spreadsheet applications, code editors, and so forth, which are independent of content management system 100.

In some example embodiments, content stored by content management system 100 includes content items, e.g., collaborative content items, created using a collaborative interface provided by collaborative content management system 130. In various implementations, collaborative content items can be stored by collaborative content item management system 130, with content management system 100, or external to content management system 100. A collaborative interface can provide an interactive content item collaborative platform whereby multiple users can simultaneously create and edit collaborative content items, comment in the collaborative content items, and manage tasks within the collaborative content items.

Users may create accounts at content management system 100 and store content thereon by sending such content from client device 120 to content management system 100. The content can be provided by users and associated with user accounts that may have various privileges. For example, privileges can include permissions to: see content item titles, see other metadata for the content item (e.g. location data, access history, version history, creation/modification dates, comments, file hierarchies, etc.), read content item contents, modify content item metadata, modify content of a content item, comment on a content item, read comments by others on a content item, or grant or remove content item permissions for other users.

Client devices 120 communicate with content management system 100 and collaborative content management system 130 through network 110. The network may be any suitable communications network for data transmission. In some example embodiments, network 110 is the Internet and uses standard communications technologies and/or protocols. Thus, network 110 can include links using technologies such as Ethernet, 802.11, worldwide interoperability for microwave access (WiMAX), 3G, 4G, digital subscriber line (DSL), asynchronous transfer mode (ATM), InfiniBand, PCI Express Advanced Switching, etc. Similarly, the networking protocols used on network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over network 110 can be represented using technologies and/or formats including the hypertext markup language (HTML), the extensible markup language (XML), JavaScript Object Notation (JSON), etc. In addition, all or some of links can be encrypted using conventional encryption technologies such as the secure sockets layer (SSL), transport layer security (TLS), virtual private networks (VPNs), Internet Protocol security (IPsec), etc. In some example embodiments, the entities use custom and/or dedicated data communications technologies instead of, or in addition to, the ones described above.

In some example embodiments, content management system 100 and collaborative content management system 130 are combined into a single system. The system may include one or more servers configured to provide the functionality discussed herein for the systems 100 and 130.

### Client Device

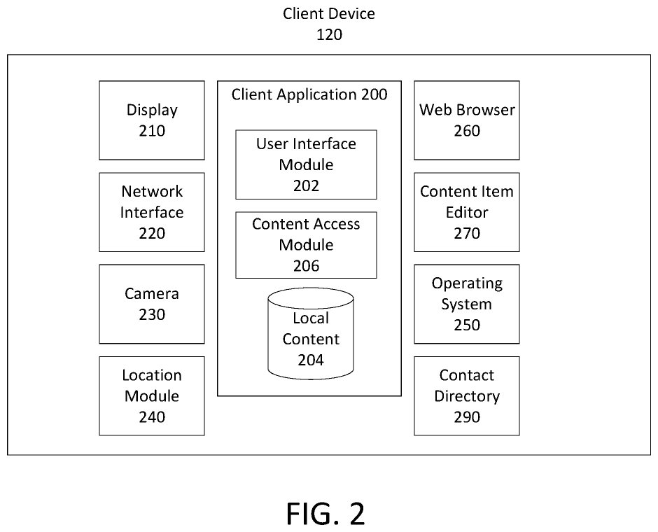

FIG. 2 shows a block diagram of the components of a client device 120 according to example embodiments. Client devices 120 generally include devices and modules for communicating with content management system 100 and a user of client device 120. Client device 120 includes display 210 for providing information to the user, and in certain client devices 120 includes a touchscreen. Client device 120 also includes network interface 220 for communicating with content management system 100 via network 110. There are additional components that may be included in client device 120 but that are not shown, for example, one or more computer processors, local fixed memory (RAM and ROM), as well as optionally removable memory (e.g., SD-card), power sources, and audio-video outputs.

In certain example embodiments, client device 120 includes additional components such as camera 230 and location module 240. Location module 240 determines the location of client device 120, using, for example, a global positioning satellite signal, cellular tower triangulation, or other methods. Location module 240 may be used by client application 200 to obtain location data and add the location data to metadata about a content item.

Client devices 120 maintain various types of components and modules for operating the client device and accessing content management system 100. The software modules can include operating system 250 or a collaborative content item editor 270. Collaborative content item editor 270 is configured for creating, viewing and modifying collaborative content items such as text documents, code files, mixed media files (e.g., text and graphics), presentations or the like. Operating system 250 on each device provides a local file management system and executes the various software modules such as content management system client application 200 and collaborative content item editor 270. A contact directory 290 stores information on the user's contacts, such as name, telephone numbers, company, email addresses, physical address, website URLs, and the like.

Client devices 120 access content management system 100 and collaborative content management system 130 in a variety of ways. Client device 120 may access these systems through a native application or software module, such as content management system client application 200. Client device 120 may also access content management system 100 through web browser 260. As an alternative, the client application 200 may integrate access to content management system 100 with the local file management system provided by operating system 250. When access to content management system 100 is integrated in the local file management system, a file organization scheme maintained at the content management system is represented at the client device 120 as a local file structure by operating system 250 in conjunction with client application 200.

Client application 200 manages access to content management system 100 and collaborative content management system 130. Client application 200 includes user interface module 202 that generates an interface to the content accessed by client application 200 and is one means for performing this function. The generated interface is provided to the user by display 210. Client application 200 may store content accessed from a content storage at content management system 100 in local content 204. While represented here as within client application 200, local content 204 may be stored with other data for client device 120 in non-volatile storage. When local content 204 is stored this way, the content is available to the user and other applications or modules, such as collaborative content item editor 270, when client application 200 is not in communication with content management system 100. Content access module 206 manages updates to local content 204 and communicates with content management system 100 to synchronize content modified by client device 120 with content maintained on content management system 100, and is one means for performing this function. Client application 200 may take various forms, such as a stand-alone application, an application plug-in, or a browser extension.

### Content Management System

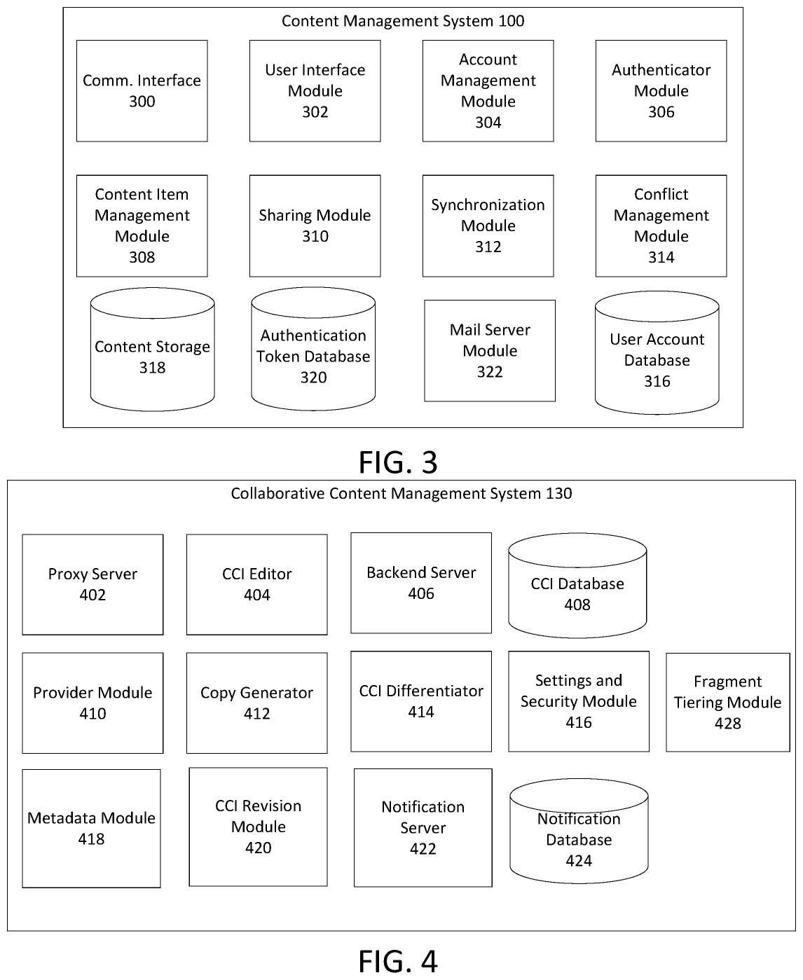

FIG. 3 shows a block diagram of the content management system 100 according to example embodiments. To facilitate the various content management services, a user can create an account with content management system 100. The account information can be maintained in user account database 316, and is one means for performing this function. User account database 316 can store profile information for registered users. In some cases, the only personal information in the user profile is a username and/or email address. However, content management system 100 can also be configured to accept additional user information, such as password recovery information, demographics information, payment information, and other details. Each user is associated with a userID and a user name. For purposes of convenience, references herein to information such as collaborative content items or other data being “associated” with a user are understood to mean an association between a collaborative content item and either of the above forms of user identifier for the user. Similarly, data processing operations on collaborative content items and users are understood to be operations performed on derivative identifiers such as collaborativeContentItemID and userIDs. For example, a user may be associated with a collaborative content item by storing the information linking the userID and the collaborativeContentItemID in a table, file, or other storage formats. For example, a database table organized by collaborativeContentItemIDs can include a column listing the userID of each user associated with the collaborative content item. As another example, for each userID, a file can list a set of collaborativeContentItemID associated with the user. As another example, a single file can list key values pairs such as <userID, collaborativeContentItemID> representing the association between an individual user and a collaborative content item. The same types of mechanisms can be used to associate users with comments, threads, text elements, formatting attributes, and the like.

User account database 316 can also include account management information, such as account type, e.g. free or paid; usage information for each user, e.g., file usage history; maximum storage space authorized; storage space used; content storage locations; security settings; personal configuration settings; content sharing data; etc. Account management module 304 can be configured to update and/or obtain user account details in user account database 316. Account management module 304 can be configured to interact with any number of other modules in content management system 100.

An account can be used to store content items, such as collaborative content items, audio files, video files, etc., from one or more client devices associated with the account. Content items can be shared with multiple users and/or user accounts. In some implementations, sharing a content item can include associating, using sharing module 310, the content item with two or more user accounts and providing for user permissions so that a user that has authenticated into one of the associated user accounts has a specified level of access to the content item. That is, the content items can be shared across multiple client devices of varying type, capabilities, operating systems, etc. The content items can also be shared across varying types of user accounts.

Individual users can be assigned different access privileges to a content item shared with them, as discussed above. In some cases, a user's permissions for a content item can be explicitly set for that user. A user's permissions can also be set based on: a type or category associated with the user (e.g., elevated permissions for administrator users or manager), the user's inclusion in a group or being identified as part of an organization (e.g., specified permissions for all members of a particular team), and/or a mechanism or context of a user's accesses to a content item (e.g., different permissions based on where the user is, what network the user is on, what type of program or API the user is accessing, whether the user clicked a link to the content item, etc.). Additionally, permissions can be set by default for users, user types/groups, or for various access mechanisms and contexts.

In some implementations, shared content items can be accessible to a recipient user without requiring authentication into a user account. This can include sharing module 310 providing access to a content item through activation of a link associated with the content item or providing access through a globally accessible shared folder.

The content can be stored in content storage 318, which is one means for performing this function. Content storage 318 can be a storage device, multiple storage devices, or a server. Alternatively, content storage 318 can be a cloud storage provider or network storage accessible via one or more communications networks. In one configuration, content management system 100 stores the content items in the same organizational structure as they appear on the client device. However, content management system 100 can store the content items in its own order, arrangement, or hierarchy.

Content storage 318 can also store metadata describing content items, content item types, and the relationship of content items to various accounts, folders, or groups. The metadata for a content item can be stored as part of the content item or can be stored separately. In one configuration, each content item stored in content storage 318 can be assigned a system-wide unique identifier.

Content storage 318 can decrease the amount of storage space required by identifying duplicate files or duplicate segments of files. Instead of storing multiple copies of an identical content item, content storage 318 can store a single copy and then use a pointer or other mechanism to link the duplicates to the single copy. Similarly, content storage 318 stores files using a file version control mechanism that tracks changes to files, different versions of files (such as a diverging version tree), and a change history. The change history can include a set of changes that, when applied to the original file version, produces the changed file version.

Content management system 100 automatically synchronizes content from one or more client devices, using synchronization module 312, which is one means for performing this function. The synchronization is platform agnostic. That is, the content is synchronized across multiple client devices 120 of varying type, capabilities, operating systems, etc. For example, client application 200 synchronizes, via synchronization module 312 at content management system 100, content in client device 120's file system with the content in an associated user account on system 100. Client application 200 synchronizes any changes to content in a designated folder and its sub-folders with the synchronization module 312. Such changes include new, deleted, modified, copied, or moved files or folders. Synchronization module 312 also provides any changes to content associated with client device 120 to client application 200. This synchronizes the local content at client device 120 with the content items at content management system 100.

Conflict management module 314 determines whether there are any discrepancies between versions of a content item located at different client devices 120. For example, when a content item is modified at one client device and a second client device, differing versions of the content item may exist at each client device. Synchronization module 312 determines such versioning conflicts, for example by identifying the modification time of the content item modifications. Conflict management module 314 resolves the conflict between versions by any suitable means, such as by merging the versions, or by notifying the client device of the later-submitted version.

A user can also view or manipulate content via a web interface generated by user interface module 302. For example, the user can navigate in web browser 260 to a web address provided by content management system 100. Changes or updates to content in content storage 318 made through the web interface, such as uploading a new version of a file, are synchronized back to other client devices 120 associated with the user's account. Multiple client devices 120 may be associated with a single account and files in the account are synchronized between each of the multiple client devices 120.

Content management system 100 includes communications interface 300 for interfacing with various client devices 120, and with other content and/or service providers via an Application Programming Interface (API), which is one means for performing this function. Certain software applications access content storage 318 via an API on behalf of a user. For example, a software package, such as an app on a smartphone or tablet computing device, can programmatically make calls directly to content management system 100, when a user provides credentials, to read, write, create, delete, share, or otherwise manipulate content. Similarly, the API can allow users to access all or part of content storage 318 through a web site.

Content management system 100 can also include authenticator module 306, which verifies user credentials, security tokens, API calls, specific client devices, etc., to determine whether access to requested content items is authorized, and is one means for performing this function. Authenticator module 306 can generate one-time use authentication tokens for a user account. Authenticator module 306 assigns an expiration period or date to each authentication token. In addition to sending the authentication tokens to requesting client devices, authenticator module 306 can store generated authentication tokens in authentication token database 320. After receiving a request to validate an authentication token, authenticator module 306 checks authentication token database 320 for a matching authentication token assigned to the user. Once the authenticator module 306 identifies a matching authentication token, authenticator module 306 determines if the matching authentication token is still valid. For example, authenticator module 306 verifies that the authentication token has not expired or was not marked as used or invalid. After validating an authentication token, authenticator module 306 may invalidate the matching authentication token, such as a single-use token. For example, authenticator module 306 can mark the matching authentication token as used or invalid, or delete the matching authentication token from authentication token database 320.

In some example embodiments, content management system 100 includes a content management module 308 for maintaining a content directory that identifies the location of each content item in content storage 318, and allows client applications to request access to content items in the storage 318, and which is one means for performing this function. A content entry in the content directory can also include a content pointer that identifies the location of the content item in content storage 318. For example, the content entry can include a content pointer designating the storage address of the content item in memory. In some example embodiments, the content entry includes multiple content pointers that point to multiple locations, each of which contains a portion of the content item.

In addition to a content path and content pointer, a content entry in some configurations also includes user account identifier that identifies the user account that has access to the content item. In some example embodiments, multiple user account identifiers can be associated with a single content entry indicating that the content item has shared access by the multiple user accounts.

In some example embodiments, the content management system 100 can include a mail server module 322. The mail server module 322 can send (and receive) collaborative content items to (and from) other client devices using the collaborative content management system 100. The mail server module can also be used to send and receive messages between users in the content management system.

### Collaborative Content Management System

FIG. 4 shows a block diagram of the collaborative content management system 130, according to example embodiments. Collaborative content items can be files that users can create and edit using a collaborative content items editor 270 and can contain collaborative content item elements. Collaborative content item elements may include any type of content such as text; images, animations, videos, audio, or other multi-media; tables; lists; references to external content; programming code; tasks; tags or labels; comments; or any other type of content. Collaborative content item elements can be associated with an author identifier, attributes, interaction information, comments, sharing users, etc. Collaborative content item elements can be stored as database entities, which allows for searching and retrieving the collaborative content items. As with other types of content items, collaborative content items may be shared and synchronized with multiple users and client devices 120, using sharing module 310 and synchronization module 312 of content management system 100. Users operate client devices 120 to create and edit collaborative content items, and to share collaborative content items with other users of client devices 120. Changes to a collaborative content item by one client device 120 are propagated to other client devices 120 of users associated with that collaborative content item.

In example embodiments of FIG. 1, collaborative content management system 130 is shown as separate from content management system 100 and can communicate with it to obtain its services. In other example embodiments, collaborative content management system 130 is a subsystem of the component of content management system 100 that provides sharing and collaborative services for various types of content items. User account database 316 and authentication token database 320 from content management system 100 are used for accessing collaborative content management system 130 described herein.

Collaborative content management system 130 can include various servers for managing access and edits to collaborative content items and for managing notifications about certain changes made to collaborative content items. Collaborative content management system 130 can include proxy server 402, collaborative content item editor 404, backend server 406, and collaborative content item database 408, access link module 410, copy generator 412, collaborative content item differentiator 414, settings module 416, metadata module 418, revision module 420, notification server 422, and notification database 424. Proxy server 402 handles requests from client applications 200 and passes those requests to the collaborative content item editor 404. Collaborative content item editor 404 manages application level requests for client applications 200 for editing and creating collaborative content items, and selectively interacts with backend servers 406 for processing lower level processing tasks on collaborative content items, and interfacing with collaborative content items database 408 as needed. Collaborative content items database 408 contains a plurality of database objects representing collaborative content items, comment threads, and comments. Each of the database objects can be associated with a content pointer indicating the location of each object within the CCI database 408. Notification server 422 detects actions performed on collaborative content items that trigger notifications, creates notifications in notification database 424, and sends notifications to client devices.

Client application 200 sends a request relating to a collaborative content item to proxy server 402. Generally, a request indicates the userID (“UID”) of the user, and the collaborativeContentItemID (“NID”) of the collaborative content item, and additional contextual information as appropriate, such as the text of the collaborative content item. When proxy server 402 receives the request, the proxy server 402 passes the request to the collaborative content item editor 404. Proxy server 402 also returns a reference to the identified collaborative content items proxy server 402 to client application 200, so the client application can directly communicate with the collaborative content item editor 404 for future requests. In alternative example embodiments, client application 200 initially communicates directly with a specific collaborative content item editor 404 assigned to the userID.

When collaborative content item editor 404 receives a request, it determines whether the request can be executed directly or by a backend server 406. When the request adds, edits, or otherwise modifies a collaborative content item the request is handled by the collaborative content item editor 404. If the request is directed to a database or index inquiry, the request is executed by a backend server 406. For example, a request from client device 120 to view a collaborative content item or obtain a list of collaborative content items responsive to a search term is processed by backend server 406.

The access module 410 receives a request to provide a collaborative content item to a client device. In some example embodiments, the access module generates an access link to the collaborative content item, for instance in response to a request to share the collaborative content item by an author. The access link can be a hyperlink including or associated with the identification information of the CCI (i.e., unique identifier, content pointer, etc.). The hyperlink can also include any type of relevant metadata within the content management system (i.e., author, recipient, time created, etc.). In some example embodiments, the access module can also provide the access link to user accounts via the network 110, while in other example embodiments the access link can be provided or made accessible to a user account and is accessed through a user account via the client device. In some example embodiments, the access link will be a hyperlink to a landing page (e.g., a webpage, a digital store front, an application login, etc.) and activating the hyperlink opens the landing page on a client device. The landing page can allow client devices not associated with a user account to create a user account and access the collaborative content item using the identification information associated with the access link. Additionally, the access link module can insert metadata into the collaborative content item, associate metadata with the collaborative content item, or access metadata associated with the collaborative content item that is requested.

The access module 410 can also provide collaborative content items via other methods. For example, the access module 410 can directly send a collaborative content item to a client device or user account, store a collaborative content item in a database accessible to the client device, interact with any module of the collaborative content management system to provide modified versions of collaborative content items (e.g., the copy generator 412, the CCI differentiator 414, etc.), sending content pointer associated with the collaborative content item, sending metadata associated with the collaborative content item, or any other method of providing collaborative content items between devices in the network. The access module can also provide collaborative content items via a search of the collaborative content item database (i.e., search by a keyword associated with the collaborative content item, the title, or a metadata tag, etc.).

The copy generator 412 can duplicate a collaborative content item. Generally, the copy generator duplicates a collaborative content item when a client device selects an access link associated with the collaborative content item. The copy generator 412 accesses the collaborative content item associated with the access link and creates a derivative copy of the collaborative content item for every request received. The copy generator 412 stores each derivative copy of the collaborative content item in the collaborative content item database 408. Generally, each copy of the collaborative content item that is generated by the copy generator 412 is associated with both the client device from which the request was received, and the user account associated with the client device requesting the copy. When the copy of the collaborative content item is generated, it can create a new unique identifier and content pointer for the copy of the collaborative content item. Additionally, the copy generator 412 can insert metadata into the collaborative content item, associate metadata with the copied collaborative content item, or access metadata associated with the collaborative content item that was requested to be copied.

The collaborative content item differentiator 414 determines the difference between two collaborative content items. In some example embodiments, the collaborative content item differentiator 414 determines the difference between two collaborative content items when a client device selects an access hyperlink and accesses a collaborative content item that the client device has previously used the copy generator 412 to create a derivative copy. The content item differentiator can indicate the differences between the content elements of the compared collaborative content items. The collaborative content item differentiator 414 can create a collaborative content item that includes the differences between the two collaborative content items, i.e., a differential collaborative content item. In some example embodiments, the collaborative content item differentiator provides the differential collaborative content item to a requesting client device 120. The differentiator 414 can store the differential collaborative content item in the collaborative content item database 408 and generate identification information for the differential collaborative content item. Additionally, the differentiator 414 can insert metadata into the accessed and created collaborative content items, associate metadata with the accessed and created collaborative content item, or access metadata associated with the collaborative content items that were requested to be differentiated.

The settings and security module 416 can manage security during interactions between client devices 120, the content management system 100, and the collaborative content management system 130. Additionally, the settings and security module 416 can manage security during interactions between modules of the collaborative content management system. For example, when a client device 120 attempts to interact within any module of the collaborative content management system 100, the settings and security module 416 can manage the interaction by limiting or disallowing the interaction. Similarly, the settings and security module 416 can limit or disallow interactions between modules of the collaborative content management system 130. Generally, the settings and security module 416 accesses metadata associated with the modules, systems 100 and 130, devices 120, user accounts, and collaborative content items to determine the security actions to take. Security actions can include: requiring authentication of client devices 120 and user accounts, requiring passwords for content items, removing metadata from collaborative content items, preventing collaborative content items from being edited, revised, saved, or copied, or any other security similar security action. Additionally, settings and security module can access, add, edit, or delete any type of metadata associated with any element of content management system 100, collaborative content management system 130, client devices 120, or collaborative content items.

The metadata module 418 manages metadata within with the collaborative content management system. Generally, metadata can take three forms within the collaborative content management system: internal metadata, external metadata, and device metadata. Internal metadata is metadata within a collaborative content item, external metadata is metadata associated with a CCI but not included or stored within the CCI itself, and device metadata is associated with client devices. At any point, the metadata module can manage metadata by changing, adding, or removing metadata.

Some examples of internal metadata can be: identifying information within collaborative content items (e.g., email addresses, names, addresses, phone numbers, social security numbers, account or credit card numbers, etc.); metadata associated with content elements (e.g., location, time created, content element type; content element size; content element duration, etc.); comments associated with content elements (e.g., a comment giving the definition of a word in a collaborative content item and its attribution to the user account that made the comment); or any other metadata that can be contained within a collaborative content item.

Some examples of external metadata can be: content tags indicating categories for the metadata; user accounts associated with a CCI (e.g., author user account, editing user account, accessing user account etc.); historical information (e.g., previous versions, access times, edit times, author times, etc.); security settings; identifying information (e.g., unique identifier, content pointer); collaborative content management system 130 settings; user account settings; or any other metadata that can be associated with the collaborative content item.

Some examples of device metadata can be: device type; device connectivity; device size; device functionality; device sound and display settings; device location; user accounts associated with the device; device security settings; or any other type of metadata that can be associated with a client device 120.

The collaborative content item revision module 420 manages application level requests for client applications 200 for revising differential collaborative content items and selectively interacts with backend servers 406 for processing lower level processing tasks on collaborative content items, and interfacing with collaborative content items database 408 as needed. The revision module can create a revised collaborative content item that is some combination of the content elements from the differential collaborative content item. The revision module 420 can store the revised collaborative content item in the collaborative content item database or provide the revised collaborative content item to a client device 120. Additionally, the revision module 420 can insert metadata into the accessed and created collaborative content items, associate metadata with the accessed and created collaborative content item, or access metadata associated with the collaborative content items that were requested to be differentiated.

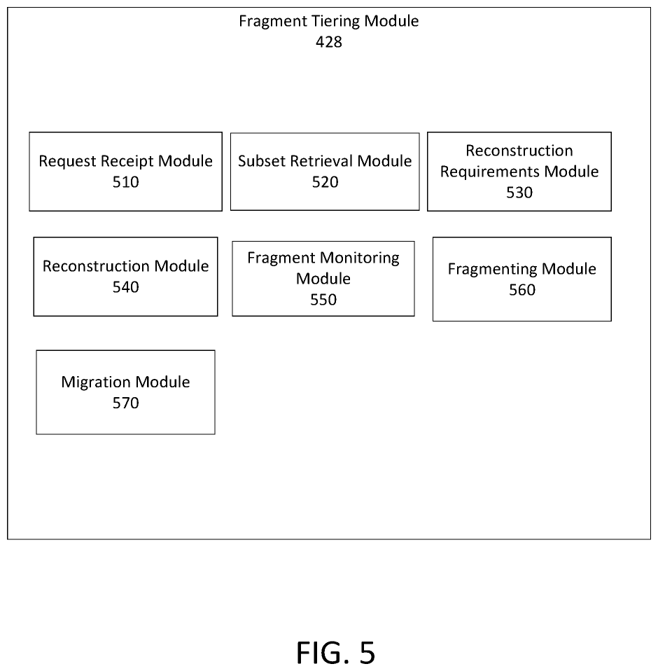

The fragment tiering module 428 manages the access and retrieval of data that has been fragmented, including the reconstruction of data, monitoring the data fragments, and migrating data fragments as needed. The fragment tiering module 428 may receive requests for data blocks stored in the content management system 100 and collaborative content management system 130, such as backend server 406 or CCI database 408. The fragment tiering module 428 may be hosted on either content management system 100 or collaborative content management system 130 and may include processes which occur on any device connected to network 110. Further details relating to operation of the fragment tiering module 428 are described below with respect to FIGS. 5-8.

Content management system 100 and collaborative content management system 130 may be implemented using a single computer, or a network of computers, including cloud-based computer implementations. The operations of content management system 100 and collaborative content management system 130 as described herein can be controlled through either hardware or through computer programs installed in computer storage and executed by the processors of such server to perform the functions described herein. These systems include other hardware elements necessary for the operations described here, including network interfaces and protocols, input devices for data entry, and output devices for display, printing, or other presentations of data, but which are not described herein. Similarly, conventional elements, such as firewalls, load balancers, collaborative content items servers, failover servers, network management tools and so forth are not shown so as not to obscure the features of the system. Finally, the functions and operations of content management system 100 and collaborative content management system 130 are sufficiently complex as to require implementation on a computer system, and cannot be performed in the human mind simply by mental steps.

FIG. 5 shows a block diagram of a fragment tiering system, according to example embodiments. FIG. 5 shows the fragment tiering module 428 and the function submodules within it, including a request receipt module 510, a subset retrieval module 520, a reconstruction requirements module 530, a reconstruction module 540, a fragment monitoring module 550, a fragmenting module 560, and a migration module 570. This is just one example embodiment, and the fragment tiering module may include fewer more modules or a different combination of modules to achieve the functionality disclosed herein.

The request receipt module 510 receives and manages the requests for a data block. As used herein, “data block” may refer to a contiguous section or unit of digital information, typically consisting of a fixed or variable number of bits or bytes. Data blocks are used as the basic building blocks of various data storage, processing, and transmission systems and algorithms, and are often used in file systems, databases, and network protocols to manage, manipulate, and transfer data, allowing efficient and systematic processing. Data blocks may also have metadata and/or headers that provide information about the block's contents or its place within a larger data set. The data block corresponds to a set of fragments, or smaller data blocks to be used for the reconstruction of the data blocks. A data block that has been fragmented is no longer contiguous. For example, the data block may be fragmented such that the system instead has three fragments that store what was once a single data block. The three fragments may include a first fragment that is half of the data block, a second fragment that is the second half of the data block, and a third fragment that is the exclusive-or (XOR) of the first two fragments. Any number of fragments may be formed from a data block, and fragments may be even or uneven in size.

The XOR function is an operation relating to binary operation that shows the comparison between two other binary pieces of information such that the output of the operation is ‘1’ (true) when the input values are different, and ‘0’ (false) when the input values are the same. The XOR operation determines whether the two input values are distinct or not. By generating an XOR fragment comparing the first and second fragments, the system has a record of the differences between the first and second fragments, such that either of the first two fragments can be recreated as long as the system has one of them along with the XOR fragment. For example, by splitting the data into three fragments in which one of the fragments is an XOR fragment and the other two are halves, the system only requires two of the three fragments for reconstruction.

As illustrated above, the data block can be reconstructed based on a specific number of fragments, and not all of the fragments may be required. For example, if the data block is fragmented into 3 fragments in which one of the three fragments is an XOR fragment of the other two, only two of the three fragments are needed for reconstruction. The fragments may be stored across a variety of storage systems and each storage system may have different characteristics. One storage system may have a higher average latency than another. One storage system may have more storage capacity than another. Once the data block is reconstructed, the request receipt module 510 provides the reconstructed data block as requested. In some embodiments, a first storage system with lower average latency is used to store the required number of fragments for reconstruction, and the remaining fragments are stored, as a backup and for the sake of redundancy, in the second storage system with higher average latency.

As used herein, “average latency” refers to the average time taken by the system to access and retrieve the requested data, including any delay experienced while the system locates the data and the actual read or write process. A system with higher average latency takes on average more time to retrieve requested data. Storage systems with lower average latency are therefore more efficient to use for data that requires more regular and frequent data retrieval and storage systems with higher average latency are more efficient to be used for data that is requested less frequently. There may be a range of storage options with different average latency and grouped into a number of categories. For example, the storage systems with the lowest average latency can be referred to as “hot” storage, the storage systems with a higher average latency can be referred to as “cool” storage, and the storage systems can be referred to as “colder” storage. An example of a colder storage system is the Amazon S3 Glacier. The number of categories of storage systems with various average latencies may vary. For example, there may be a binary of “hot” and “cold” or may be more, such as 6 categories going from “hotter” to “hot” to “warm” to “cool” to “cold” to “colder”. As used herein, a “colder” storage system is a storage system with a higher average latency (e.g., data retrieval latency) in a comparison to another system, and a “hotter” storage system is a storage system with a lower average latency in a comparison. Average latency as used as a measure in the discussion herein is merely exemplary and any statistical representation of latency over time for each storage system equally applies to the storage systems as discussed.

Considerations that distinguish the storage systems in the various categories may also include system performance, reliability, scalability, capacity, accessibility, security, geographic distribution, and energy distribution. Different storage systems may have varying throughput and read/write speeds affecting data access and processing times. Storage systems may have varying levels of error detection and correction mechanisms to minimize data loss or corruption. Geographic distribution may ensure low latency access for data requests. Different storage systems may have different energy consumption requirements and the consideration of energy in storing fragments across the system may allow for monitoring and meeting the energy consumption of the system overall.

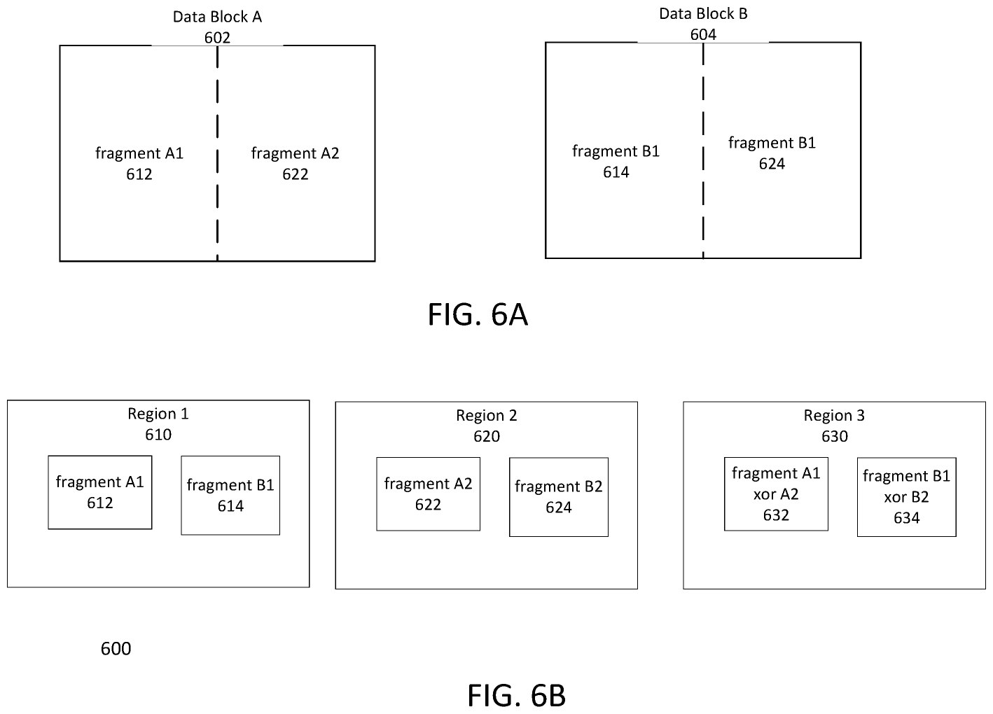

Briefly turning to FIGS. 6A and 6B, FIGS. 6A and 6B are illustrative of fragments stored across a storage system. FIG. 6A shows data blocks divided into fragments, according to some example embodiments. FIG. 6B shows a block diagram of a data blocks fragmented across a storage system, according to example embodiments. This is only an example of a fragmentation and storage system. Alternate methods of fragmenting and storing are also included by this system. FIG. 6A includes data block A 602 and data block B 604, each indicating the corresponding fragments. Storage system 600 includes a first region 610, a second region 620, and a third region 630. Each region stores fragments of data blocks A and B. As illustrated, the first region 610 is storing fragments 612 and 614, the second region 620 is storing fragments 622 and 624, and the third region is storing fragments 632 and 634. Each region is its own storage system associated with a designated geographic area or metro. Each region has its own redundancies within the system to account for failures within the system. The storage of data across multiple regions ensures redundancies for when there is a catastrophic failure within region's system.

In response to receiving a request to store a data block, the data block is fragmented and stored across regions within the storage system 600. For example, data block A 602 is split into fragment 612, and fragment 622. In some embodiments, additional fragments are created such as the fragment 632 which is created via the operation of fragment 612 XOR fragment 622. Data block A 602 has been fragmented into fragments 612, 622, and 632. Fragments 612 and 622 are each simply one half of data block A. Fragment 632 is the exclusive-or of fragments 612 and 622. Data block B 604 has been fragmented into fragments 614, 624, and 634. Fragments 614 and 624 are each simply one half of data block B. Fragment 634 is the exclusive-or of fragments 614 and 624. In this way, only two of the three corresponding fragments are needed for each of the data blocks A or B.

Each of the regions with storage system 600 may share or differ in their storage capacity and characteristics. Each of these regions may be associated with different geographic locations or may have different storage options and requirements. For example, the first region 610 may have a colder storage than the third region 630. The second region 620 may have a larger storage capacity than the first region 610. The fragment tiering module 428 may store fragments within specific regions of the storage system 600 based on these various characteristics. In some embodiments, fragments may be stored in specific regions such that a minimum number of fragments required for reconstruction is stored in one storage system or region, while any remaining fragments are stored in alternative (e.g., colder) storage systems or regions. Returning to FIG. 5, the subset retrieval module 520, responsive to the request receipt module 510 receiving a request, retrieves and manages required fragments for reconstruction. In some embodiments, the subset retrieval module 520 requests and retrieves only the required number of fragments for reconstruction. In some embodiments, the subset retrieval module 520 requests and retrieves all fragments within a designated storage system, such as all hotter storage systems. A designated storage system may refer to a policy in which the system is set to default to and otherwise prefer fragments from certain categories of storage systems or specific storage systems. For example, the fragment tiering module 428 may have a set policy for defaulting to requesting all fragments for storage systems designated as hot storage. In some embodiments, the subset retrieval module 520 requests all fragments and uses only the first fragments to be retrieved. The reconstruction requirements module 530, described below, determines when the reconstruction requirements have been met, and when more fragments are needed. The subset retrieval module 520 may, in response to the reconstruction requirements module 530, request and retrieve additional fragments if the reconstruction requirements have not been met.

The subset retrieval module 520 may request fragments from specific storage systems based on a specific priority or designed order. The subset retrieval module 520 may, by default, only request fragments from the first storage system, or set of storage regions, unless notified by the reconstruction requirements 530 module, that more fragments are needed. Responsive to receiving a notification by the reconstruction requirements module, the subset retrieval module 520 may request fragments from a second storage system that is less preferred, such as one with a colder storage. For example, the subset retrieval module 520 may have instructions to always attempt to retrieve fragments from the first region 610 and the second region 620 before the third region 630. The subset retrieval module 520 may wait until instructed otherwise to retrieve fragments from the third region 630. The subset retrieval module 520 may request fragments from alternate options, such as the third region 630, after a set amount of time has elapsed without receiving fragments from one the initial requests, such as requests for fragments from the first region 610 or second region 620.

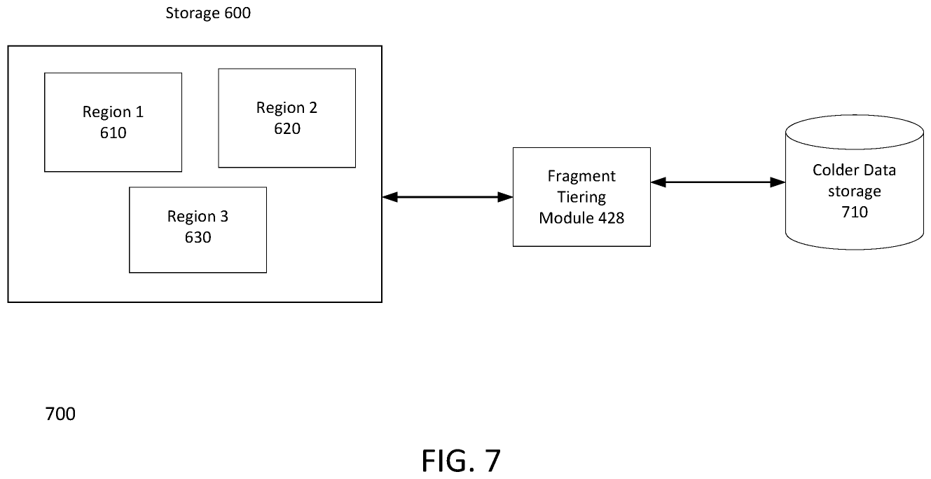

Briefly turning to FIG. 7, FIG. 7 is illustrative of a fragment tiering across multiple storage systems. FIG. 7 shows the block diagram of the fragment tiering system across two storage systems, in accordance with some embodiments. System 700 includes the fragment tiering module 428, a colder data storage 710, and the storage system 600, with the first region 610, second region 620, and third region 630. The colder data storage 710 has a higher average latency than any of the regions within the storage system 600. The fragment tiering module 428 monitors and manages the fragments across both systems, retrieving fragments as needed, and moving fragments within the storage system 600 or between the storage system 600 and the colder data storage 710 as needed. In some embodiments, the fragment tiering module 428 may store the required number of fragments for reconstruction in the designated storage options, and may store the remaining fragments in the less preferred storage option. For example, if a data block A requires two fragments to be reconstructed and the storage system 600 is preferred, the fragment tiering module 428 may store two of the required fragments in the storage system 600 and the remaining fragment in the colder data storage 710.

Returning to FIG. 5, the reconstruction requirements module 530 determines whether the reconstruction requirements are met. Responsive to receiving less than a threshold number of fragments, the reconstruction requirements module 530 notifies the subset retrieval module 520. The threshold number of fragments is the minimum number of fragments required to reconstruct the data block. The minimum number of fragments required to reconstruct the data block is determined by how the fragments are split and the relation of the fragments to each other. For example, in embodiments in which the data block is fragmented into quarters and each fragment is one quarter of the data block, four fragments are required. In another example, in embodiments in which some fragments are one half of the data block and another fragment is an XOR fragment, only two fragments would be required. For example, for data block A, the minimum number of data blocks is two of the three fragments 612, 622, and 632, and so the threshold number for data block A is two. The threshold number of fragments depends on how many fragments are associated with the data block and the fragmenting framework used. Different data blocks may be fragmented into a differing number of fragments or may be using different fragmenting frameworks, and so the threshold number of fragments may depend on the data block being reconstructed.

The notification to subset retrieval module 520 may include instructions to retrieve fragments from alternate storage systems that are not the default. For example, the subset retrieval module 520 may always retrieve fragments from storage system 600 unless instructed to otherwise from reconstruction requirements module 530. Responsive to instructions from the reconstruction requirements module 530, the subset retrieval module 520 may retrieve fragments from the colder data storage 710.

The reconstruction module 540 reconstructs the data block using the retrieved fragments from subset retrieval module 520. For example, the reconstruction module 540 assembles the data block A from retrieved fragments 612 and 614. As used herein, “reconstruction” refers to the process of reassembling and restoring information that has been either fragmented, encoded, compressed, or otherwise transformed into a different format or representation. Reconstruction of data may involve various techniques and methodologies, depending on the original format and nature of the data. For example, in embodiments in which the fragments to use in reconstruction are fragment 612 and fragment 632, such that one fragment is an XOR fragment, the reconstruction process includes the re-creation of fragment 622 from fragment 612 and 632, and then the combination of fragment 612 and fragment 622, each being one half of data block A, to reconstruct data block A. The alignment of the fragments to reconstruct the data block may be indicated by a header of each fragment or in other metadata associated with the fragment.

The fragment monitoring module 550 monitors the fragments and the associated storage systems in order to detect that a fragment is compromised (e.g., corrupted or inaccessible due to a physical hardware failure). Responsive to detecting that at least one of the fragments is compromised, the fragment monitoring module 550 flags to the subset retrieval module 520, that the fragments need to be retrieved in order to reconstruct and re-fragment the data and preserve the data block. The fragments may be monitored by monitoring access to the storage system. For example, responsive to the fragment monitoring module 550 losing contact with region first region 610 of storage system 600, the fragment monitoring module 550 may determine that that fragments 612 and 614 are compromised. By reconstructing data blocks A and B using the remaining fragments in the remaining regions of the second region 620 and the third region 630, the fragment tiering module 428 may the recreate the fragments 612 and 614.

The fragmenting module 560 fragments a data block into fragments, also known as fragments. The fragmenting module 560 may receive the data block from the reconstruction module 540 as part of the process of regenerating fragments when one is compromised. The fragmenting module 560 may receive a data block when a data block is moved between storage systems and needs to be fragmented and stored. For example, the fragmenting module 560 may fragment data block A by separating the data block A in half, creating fragments 612 and 622, and then doing an XOR operation between fragments 612 and 622 to generate fragment 632.

The migration module 570 manages the migration of the fragments of data between and among the storage systems. The migration module 570 may detect a request to migrate a plurality of data blocks. For example, the request may be to migrate data blocks from the storage system 600 to the colder data storage 710 in order to increase the available storage in the storage system 600. Responsive to detecting the request, the migration module 570 identifies fragments in the first storage system associated with each of the data blocks from the request and stored in the first storage system. For example, in response to a request to move data blocks A and B from the storage system 600 to the colder data storage 710, the migration module 570 identifies each of the fragments 612, 614, 622, 624, 632, and 634 for migration. The migration module 570 may then migrate identified fragments to a second storage system, such as the colder data storage 710. The migration module 570 may migrate fragments within the storage system 600 such as between the first region 610, the second region 620, and the third region 630. The migration module 570 may migrate fragments between regions based on preferred storage systems, average latency of various storage options, or the geographic locations associated with each region.

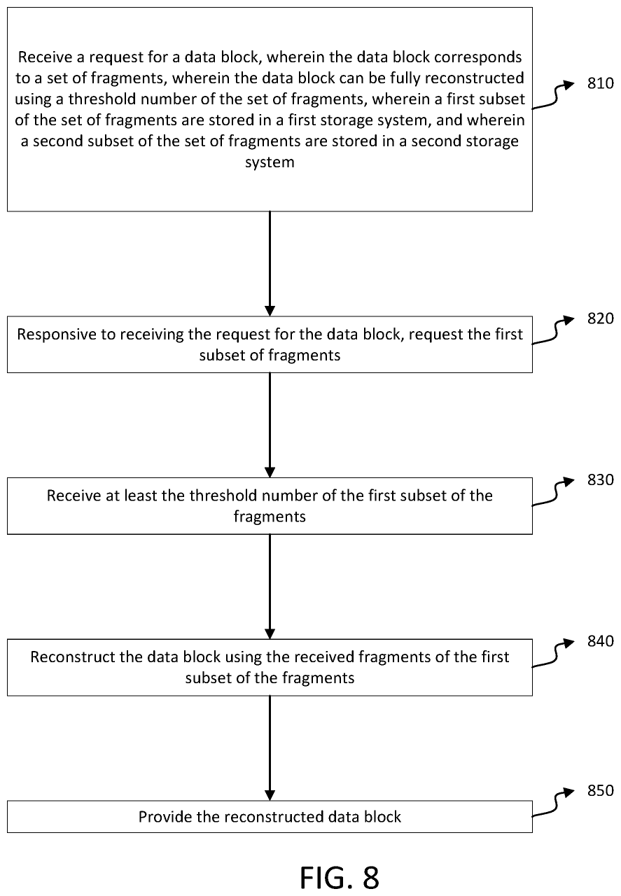

FIG. 8 shows a flowchart of an example method of a fragment tiering system, according to example embodiments. The process 800 may be performed by the fragment tiering module 428, and may be performed without human intervention. FIG. 8 is a non-limiting example of some embodiments. The process 800 may occur in alternate orders and arrangements, as well as with additional or fewer steps.

The request receipt module 510 receives 810 a request for a data block. The data block corresponds to a set of fragments and the data block can be fully reconstructed using a threshold number of the set of fragments. A first subset of the set of fragments are stored in a first storage system, and a second subset of the set of fragments are stored in a second storage system. The second storage system may be a colder storage than the first storage system.

The subset retrieval module 520, responsive to receiving the request for the data block, requests 820 the first subset of the set of fragments. Responsive to receiving less than the threshold number of the first subset of the fragments, the subset retrieval module 520 may requests the second subset of the set of fragments from the second storage system.

The subset retrieval module 520 receives 830 at least the threshold number of the first subset of the fragments. The reconstruction requirements module 530 may determine whether the threshold number of fragments have been received such that the number of received fragments meets the reconstruction requirement.

The reconstruction module 540 reconstructs 840 the data block using the received fragments of the first subset of the fragments. In some embodiments, the reconstruction module 540 reconstructions 840 the data block using only the fragments from a first storage system and without requesting fragments from a second storage system. The first storage system may be a preferred storage system due to being a hotter storage system. The preferred storage system for a fragment or data block may be dependent on the expected frequency for the need to access the data.

The request receipt module 510 provides 850 the reconstructed data block per the received request. For example, responsive to a request for data block A, the request receipt module 510 provides data block A as reconstructed from fragments such as fragments 612, 622 and 632.

### ADDITIONAL CONSIDERATIONS

Reference in the specification to “one embodiment” or to “example embodiments” means that a particular feature, structure, or characteristic described in connection with the example embodiments is included in at least one embodiment. The appearances of the phrase “in one embodiment” in various places in the specification are not necessarily all referring to the same embodiment.

In this description, the term “module” refers to a physical computer structure of computational logic for providing the specified functionality. A module can be implemented in hardware, firmware, and/or software. In regards to software implementation of modules, it is understood by those of skill in the art that a module comprises a block of code that contains the data structure, methods, classes, header and other code objects appropriate to execute the described functionality. Depending on the specific implementation language, a module may be a package, a class, or a component. It will be understood that any computer programming language may support equivalent structures using a different terminology than “module.”

It will be understood that the named modules described herein represent one embodiment of such modules, and other example embodiments may include other modules. In addition, other example embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of a system, loaded into memory, and executed by the one or more processors of the system's computers.

The operations herein may also be performed by an apparatus. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including optical disks, CD-ROMs, read-only memories (ROMs), random access memories (RAMs), magnetic or optical cards, or any type of media suitable for storing electronic instructions, and each coupled to a computer system bus. Furthermore, the computers referred to in the specification may include a single processor or may be architectures employing multiple processor designs for increased computing capability.

The algorithms presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present technology is not described with reference to any particular programming language. It will be appreciated that a variety of programming languages may be used to implement the teachings of the present technology as described herein, and any references above to specific languages are provided for disclosure of enablement and best mode of the present technology.

While the technology has been particularly shown and described with reference to a preferred embodiment and several alternate example embodiments, it will be understood by persons skilled in the relevant art that various changes in form and details can be made therein without departing from the spirit and scope of the technology.

As used herein, the word “or” refers to any possible permutation of a set of items. Moreover, claim language reciting ‘at least one of’ an element or another element refers to any possible permutation of the set of elements.

Although this description includes a variety of examples and other information to explain embodiments within the scope of the appended claims, no limitation of the claims should be implied based on particular features or arrangements these examples. This disclosure includes specific example embodiments and implementations for illustration, but various modifications can be made without deviating from the scope of the example embodiments and implementations. For example, functionality can be distributed differently or performed in components other than those identified herein. This disclosure includes the described features as non-exclusive examples of systems components, physical and logical structures, and methods within its scope.

Finally, it should be noted that the language used in the specification has been principally selected for readability and instructional purposes, and may not have been selected to delineate or circumscribe the inventive subject matter. Accordingly, the disclosure of the present technology is intended to be illustrative, but not limiting, of the scope of the technology, which is set forth in the following claims.

What is claimed is:

1. A method comprising:
receiving a request for a data block, wherein the data block corresponds to a set of fragments, wherein the data block can be fully reconstructed using a threshold number of the set of fragments, wherein a first subset of the set of fragments are stored in a first storage system, and wherein a second subset of the set of fragments are stored in a second storage system;
responsive to receiving the request for the data block, requesting the first subset of the set of fragments;
receiving at least the threshold number of the first subset of the fragments;
reconstructing the data block using the received fragments of the first subset of the fragments; and
providing the reconstructed data block.

2. The method of claim 1, further comprising:
receiving a second request for a second data block, wherein the second data block corresponds to a second set of fragments stored in the first storage system;
requesting the second set of fragments from the first storage system;
receiving at least the threshold number of fragments of the second set of fragments from the first storage system; and
reconstructing the second data block based on the received set of fragments.

3. The method of claim 1, further comprising:
responsive to receiving less than the threshold number of the first subset of the fragments, requesting the second subset of the set of fragments from the second storage system; and
reconstructing the data block using the received fragments of the first subset of the fragments and the second subset of the fragments.

4. The method of claim 1, wherein reconstructing the data block further comprises reconstructing the data block without requesting the second subset of the set of fragments.

5. The method of claim 1, further comprising:
detecting that at least one of the fragments in the first subset of the set of fragments is compromised;
responsive to detecting that at least one of the fragments is compromised, requesting the threshold number of fragments from a combination of the first subset of the set of fragments and the second subset of the set of fragments;
receiving the requested threshold number of fragments;
in response to receiving the requested threshold number of fragments, reconstructing the data block using the received threshold number of fragments; and
storing the reconstructed data block across the first storage system and the second system.

6. The method of claim 1, wherein the first subset of the fragments comprises a number of fragments equal to the threshold number, and wherein any remaining fragments above the threshold number are stored as part of the second subset in the second storage system.

7. The method of claim 1, further comprising:
detecting a request to migrate a plurality of data blocks;
responsive to detecting the request to migrate the plurality of data blocks, identifying a plurality of fragments stored in the first storage system, wherein each of the plurality of fragments is associated with one of the plurality of data blocks; and
migrating the identified plurality of fragments to the second storage system.

8. The method of claim 7, wherein identifying a plurality of fragments stored in the first storage system further comprises identifying fragments to migrate to the second storage based on geographic location associated with the first storage system and second storage system.

9. The method of claim 1, wherein one of the fragments is an exclusive-or of two other fragments.

10. The method of claim 1, wherein the second storage system is characterized by a higher average latency than the first storage system.

11. The method of claim 1, further comprising:
receiving a request to store a new data block;
dividing the new data block into a plurality of fragments;
identifying a required number of fragments for reconstruction; and
storing the required number of fragments for reconstruction in the first storage system, and any remaining fragments in the second storage system.

12. A non-transitory computer-readable medium comprising memory with instructions encoded thereon that, when executed by one or more processors, cause the one or more processors to perform operations, the instructions comprising instructions to:
receive a request for a data block, wherein the data block corresponds to a set of fragments, wherein the data block can be fully reconstructed using a threshold number of the set of fragments, wherein a first subset of the set of fragments are stored in a first storage system, and wherein a second subset of the set of fragments are stored in a second storage system;
responsive to receiving the request for the data block, request the first subset of the set of fragments;
receive at least the threshold number of the first subset of the fragments;
reconstruct the data block using the received fragments of the first subset of the fragments; and
provide the reconstructed data block.

13. The non-transitory computer-readable storage medium of claim 12, wherein the instructions further comprise instructions to:
receive a second request for a second data block, wherein the second data block corresponds to a second set of fragments stored in the first storage system;
request the second set of fragments from the first storage system;
receive at least the threshold number of fragments of the second set of fragments from the first storage system; and
reconstruct the second data block based on the received set of fragments.

14. The non-transitory computer-readable storage medium of claim 12, wherein the instructions further comprise instructions to:
responsive to receiving less than the threshold number of the first subset of the fragments, request the second subset of the set of fragments from the second storage system; and
reconstruct the data block using the received fragments of the first subset of the fragments and the second subset of the fragments.

15. The non-transitory computer-readable storage medium of claim 12, wherein the instructions further comprise instructions to:
detect that at least one of the fragments in the first subset of the set of fragments is compromised;
responsive to detecting that at least one of the fragments is compromised, request the threshold number of fragments from a combination of the first subset of the set of fragments and the second subset of the set of fragments;
receive the requesting threshold number of fragments;
in response to receiving the requested threshold number of fragments, reconstruct the data block using the received threshold number of fragments; and
store the reconstructed data block across the first storage system and the second system.

16. The non-transitory computer-readable storage medium of claim 12, wherein the instructions further comprise instructions to:
detect a request to migrate a plurality of data blocks;
responsive to detecting the request to migrate the plurality of data blocks, identify a plurality of fragments stored in the first storage system, wherein each of the plurality of fragments is associated with one of the plurality of data blocks; and
migrate the identified plurality of fragments to the second storage system.

17. The non-transitory computer-readable storage medium of claim 16, wherein the instructions to identify a plurality of fragments stored in the first storage system further comprise instructions to identify fragments to migrate to the second storage based on geographic location associated with the first storage system and second storage system.

18. The non-transitory computer-readable storage medium of claim 12, wherein the second storage system is characterized by a higher average latency than the first storage system.

19. A system comprising:
memory with instructions encoded thereon; and
one or more processors that, when executing the instructions, are caused to perform operations comprising:
receiving a request for a data block, wherein the data block corresponds to a set of fragments, wherein the data block can be fully reconstructed using a threshold number of the set of fragments, wherein a first subset of the set of fragments are stored in a first storage system, and wherein a second subset of the set of fragments are stored in a second storage system characterized by a higher average latency than the first storage system;
responsive to receiving the request for the data block, requesting the first subset of the set of fragments;
receiving at least the threshold number of the first subset of the fragments;
reconstructing the data block using the received fragments of the first subset of the fragments; and
providing the reconstructed data block.

20. The system of claim 19 wherein the operations further comprise:
responsive to receiving less than the threshold number of the first subset of the fragments, requesting the second subset of the set of fragments from the second storage system; and
reconstructing the data block using the received fragments of the first subset of the fragments and the second subset of the fragments.
